(19) United States
(12) Patent Application Publication
(10) Pub. No.: US 2024/0136608 A1
(43) Pub. Date: Apr. 25, 2024

(54) THERMAL REGULATION OF CONVECTIVE FLOW BATTERIES AND RELATED METHODS

(71) Applicant: Massachusetts Institute of Technology, Cambridge, MA (US)

(72) Inventors: Fikile Richard Brushett, Cambridge, MA (US); Weiran Gao, Boston, MA (US); Javit Drake, Jamaica Plain, MA (US)

(73) Assignee: Massachusetts Institute of Technology, Cambridge, MA (US)

(21) Appl. No.: 18/482,824

(22) Filed: Oct. 6, 2023

Related U.S. Application Data
(60) Provisional application No. 63/414,399, filed on Oct. 7, 2022.

(51) Int. Cl. H01M 10/48; H01M 10/052; H01M 10/44

(52) U.S. Cl. CPC H01M 10/486; H01M 10/052; H01M 10/443

(57) ABSTRACT

The systems and methods for monitoring and/or regulating thermal parameters in convective flow batteries is generally described.

### RELATED APPLICATIONS

This application claims priority under 35 U.S.C. § 119(e) to U.S. Provisional Application No. 63/414,399, filed Oct. 7, 2022, and entitled “THERMAL REGULATION OF CONVECTIVE FLOW BATTERIES AND RELATED METHODS,” which is incorporated herein by reference in its entirety for all purposes.

### TECHNICAL FIELD

Systems and methods for monitoring and/or regulating thermal parameters in convective flow batteries are generally described.

### BACKGROUND

Batteries generate heat as they operate, and the generated heat may negatively impact the performance of the battery. For example, heat generated as the battery operates may degrade the cathode, the anode, or the electrolyte of the battery. Furthermore, heat generated during battery performance may inadvertently result in the combustion of flammable solvents used in the battery electrolyte. Accordingly, management of heat generated by a battery is important when considering both the performance of the battery and related safety considerations.

Conventional batteries typically have no internal thermal management, so heat must be regulated external to the battery. However, design considerations of the device to be powered by the battery often limit the amount of external heat management available to the battery. Accordingly, systems and methods for internally regulating the heat generated by batteries are desired.

### SUMMARY

The systems and methods for monitoring and/or regulating thermal parameters in convective flow batteries is generally described. The subject matter of the present disclosure involves, in some cases, interrelated products, alternative solutions to a particular problem, and/or a plurality of different uses of one or more systems and/or articles.

In one aspect, a method of operating an electrochemical system with convection, is described, the method comprising circulating an electrolyte comprising an electroactive species in an electrochemical cell comprising a positive electrode, a separator, a negative electrode; applying a voltage between the positive electrode and the negative electrode; and determining one or more thermal parameters of the electrochemical cell.

In another aspect, a method of operating an electrochemical system with convection is described, the method comprising circulating an electrolyte comprising an electroactive species in an electrochemical cell comprising a positive electrode, a separator, a negative electrode; applying a voltage between the positive electrode and the negative electrode, wherein the electrochemical system satisfies the condition

$$\frac{{\overline{Q}}_{total} L}{2 {h}_{cell} ( {T}_{max} - {T}_{ambient} ) + {ρ}_{e} {C}_{p . e} v ( {T}_{max} - {T}_{tank , init} )} < 3 ,$$

where Q̅ₜₒₜₐₗ is an average volumetric heat generation rate inside an electrochemical cell of the system, L is a characteristic length of internal flow, h_{cell} is the heat transfer coefficient of the cell, Tₘₐₓ is a threshold temperature of the cell, T_{ambient} is an ambient temperature, ρₑ is an electrolyte density, C_{p,e} is an electrolyte heat capacity, and v is an electrolyte superficial velocity, and T_{tank,init} is an initial temperature of the electrolyte inside an external storage tank.

In another aspect, a convection-enhanced battery system, is described the system comprising a positive electrode comprising a lithium intercalation compound; a separator adjacent to the positive electrode; a negative electrode adjacent to the separator, the negative electrode comprising lithium-intercalated graphite or lithium metal; a tank comprising an electrolyte; a pump connected to the tank to circulate the electrolyte; a thermal regulator, wherein the thermal regulator is configured to heat and cool the electrolyte.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B are schematic diagrams of electrochemical systems configured to provide convection to the electrolyte, according to some embodiments;

FIGS. 1C-1D are schematic diagrams of an electrochemical system comprising a thermal regulator and a temperature sensor, according to some embodiments;

FIG. 2 is block diagram of an example general purpose computer configured to operate an electrochemical system according to one or more thermal parameters, according to one set of embodiments;

FIGS. 3A-3B are schematic diagrams of a electrochemical cell with convection, according to some embodiments;

FIGS. 4A-4C are plots illustrating the base case for comparing thermal regulation, according to some examples;

FIGS. 5A-5D illustrate the pseudo-Isothermal case, where the figures are taken at the end of the no-flow rate condition in the base case, noting that the results shown in FIG. 5A are slightly different than FIG. 5B because here a different electrolyte diffusivity and transference number values were chosen to represent the current electrolyte material in use, and where the Joule heating in the current collectors is negligible and not shown, according to some embodiments;

FIG. 6 shows plots that illustrate the heat transfer only case (high diffusivity), according to some embodiments;

FIG. 7 is a plot that illustrates different types of cooling regimes, according to some embodiments;

FIG. 8 is a plot illustrating the potential use case that demonstrates dynamic flow rate for thermoregulation, according to some embodiments;

FIGS. 9A-9B are plots that show (a) convection triggered by temperature (b) convection triggered by change in current density, according to some embodiments;

FIG. 10 describes thermal parameters, according to some embodiments; and

FIG. 11 shows a battery system configured to control circulation of an electrolyte of the battery, according to some embodiments.

### DETAILED DESCRIPTION

Systems and methods for monitoring and/or regulating heat within electrochemical cells and/or batteries are generally described below. Many conventional batteries and electrochemical systems can only have their temperatures and heat profiles regulated externally (e.g., through contact with the external environment, such as air of the external environment), which limits the ability to regulate heat transfer in these batteries and electrochemical systems. Electrochemical systems that utilize convection may help to improve heat dissipation in the system, where convection within the system not only increases transport of the electroactive species but may also improve heat transfer within the system. However, it has yet to be recognized or understood how flow within a convective electrochemical system must be modulated (e.g., increased, decreased) in order to maintain the desired performance of the system (e.g., battery capacity, electrolyte stability). Specifically, while heating may improve reaction kinetics, it may also speed of electrolyte degradation. Conversely, cooling may improve electrolyte stability, but may also cause solubility issues of the electroactive species (e.g., the electroactive species may participate out if the electrolyte is cooled too much, the electrolyte solvent may freeze) if the system is cooled too much.

The Inventors have recognized and appreciated that effectively regulating one or more thermal parameters of electrochemical systems with convection may improve the performance of the electrochemical system. Specifically, it has been discovered that by providing certain heating, cooling, and/or flowrates of the electrolyte, the performance of the electrochemical system (e.g., electrochemical cell(s), batteries) can be improved and/or maintained at a desired level. These improvements, as outlined more fully in this disclosure and the accompanying figures, can relate to at least one or more of better cell performance (e.g., better overall cell capacity as a function of time and discharge), better distribution of important electrolyte components such as lithium ion and/or other species (which can be more even distribution, or uneven distribution of that is advantageous), and reduced heat generated by the cell (i.e., thermal management according to this disclosure not only can remove heat from a cell, but can cause that cell to produce less heat itself during operation). Where one improvement is more even or otherwise better distribution of at least one electrolyte component, this can itself lead to reduced heat generation, and/or better electrochemical reactivity in the cell, for example better cell reaction uniformity.

The systems and methods described herein are generally applicable to electrochemical systems that include convection (e.g., convection batteries). Those skilled in the art understand that a convection-enhanced electrochemical cell or a convection battery is distinct from a flow cell battery. A flow cell battery uses two liquid electrolytes, a catholyte and an anolyte, each of which comprises a cathode active material and an anode active material, respectively. By contrast, a convection battery may use just a single electrolyte circulated to both the positive electrode (e.g., a cathode) and the negative electrode (e.g., an anode), wherein a solid, positive electrode comprises the cathode active material and/or a solid, negative electrode comprises the anode active material. Thus, those skilled in the art would also understand the electrolyte requirements of a convection battery with a single electrolyte are distinct from those of flow cell batteries with two electrolytes, a catholyte and an anolyte.

The various systems and methods described herein may determine one or more thermal parameters (e.g., derived thermal parameters) in order to determine (at least in part) how the system should be adjusted to regulate heat. For example, if a temperature sensor of the system determines that the system (e.g., an electrolyte of the system) if above a threshold temperature of the system, the system (e.g., a controller of the system) may adjust (e.g., increase convection, increase flow rate of the electrolyte of the system) to bring the system back under this this threshold system. In some embodiments, the system satisfies the condition

$$\frac{{\overline{Q}}_{total} L}{2 {h}_{cell} ( {T}_{max} - {T}_{ambient} ) + {ρ}_{e} {C}_{p . e} v ( {T}_{max} - {T}_{tank , init} )} < 3 ,$$

where Q̅ₜₒₜₐₗ is an average volumetric heat generation rate inside an electrochemical cell of the system, L is a characteristic length of internal flow, h_{cell} is the heat transfer coefficient of the cell, Tₘₐₓ is a threshold temperature of the cell, T_{ambient} is an ambient temperature, ρₑ is an electrolyte density, C_{p,e} is an electrolyte heat capacity, and v is an electrolyte superficial velocity, and T_{tank,init} is an initial temperature of the electrolyte inside an external storage tank. In some embodiments, Q̅ₜₒₜₐₗ has the range of greater than or equal to 100 and/or less than or equal to 10,000,000 W/m³. In some embodiments, L is greater than or equal to 50 μm and/or less than or equal to 1 m. In some embodiments, ρₑ is greater than or equal to 100 and/or less than or equal to 10,000 kg/m³. In some embodiments, C_{p,e} is greater than or equal to 100 and/or less than or equal to 10,000 J/(kg/K). In some embodiments, v greater than or equal to 0.001 μm/s and/or less than or equal to 1 m/s.

Turning to the figures, specific, non-limiting embodiments are described in further detail. It should be understood that the various components, features, systems, assays, and methods described relative to these embodiments may be used either individually and/or in any desired combination as this disclosure is not limited to only the specific embodiments described herein.

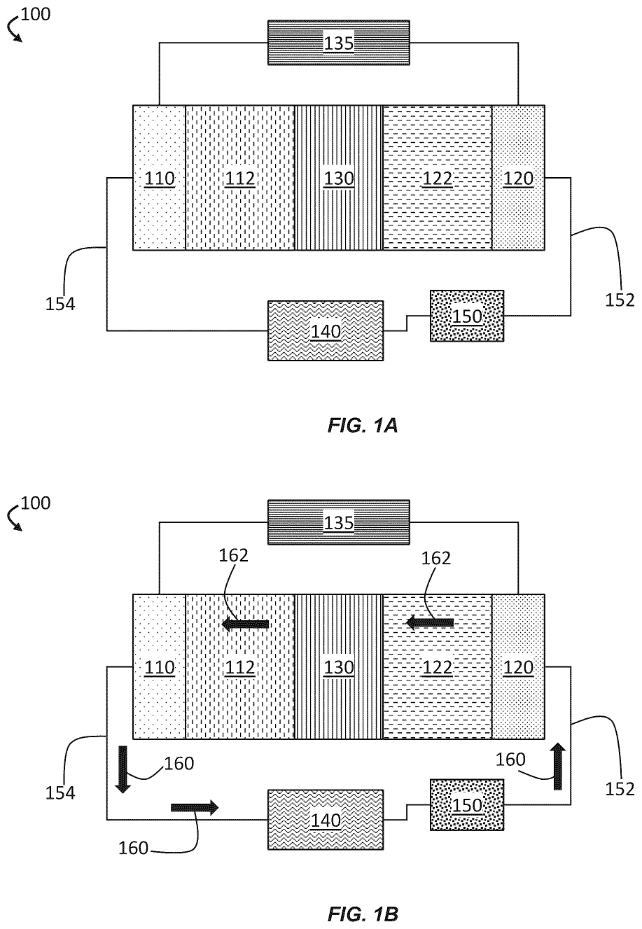

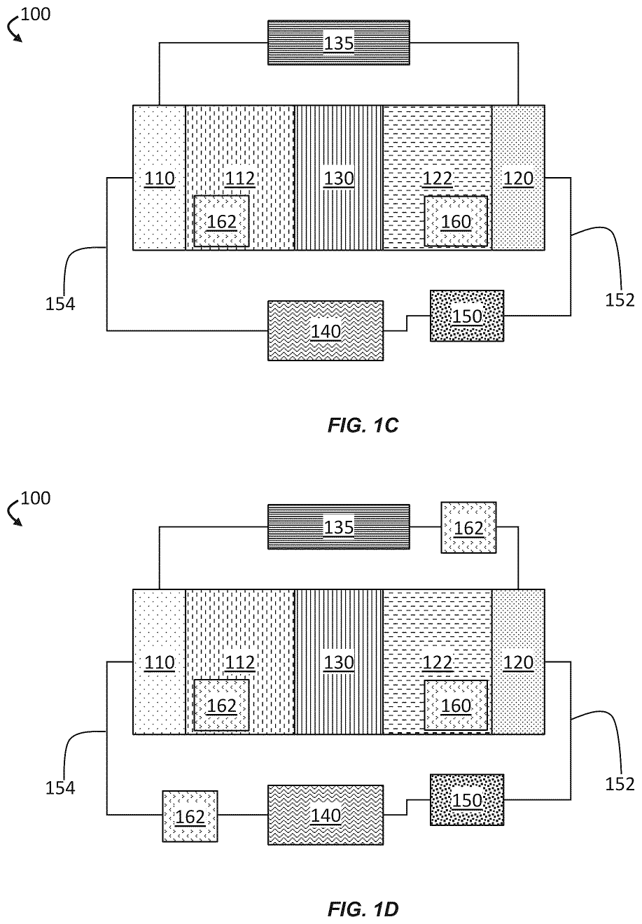

In some embodiments, a method for operating an electrochemical cell with convection is described. For example, in FIG. 1A, a convection-enhanced system 100 is shown. The system 100 comprises a positive electrode 110 and a negative electrode 120 separated by a separator 130. The separator 130 may divide the system 100 into a positive electrode side 112 and a negative electrode side 122, which may each contain an electrolyte (not pictured) shared between both sides, such that the single electrolyte may freely pass through the separator 130 while providing a degree of separation between the positive electrode side 112 and the negative electrode 122. Also shown in the figure is an electrical load 135, which may represent a source of power being taken from the system (e.g., a light bulb, a computer, a vehicle).

In some embodiments, systems and methods may also include tank for containing an electrolyte (e.g., an electrolyte) and a pump for flowing the electrolyte through the tank and within the electrochemical cell. For example, in FIG. 1A, system 100 includes a tank 140 connected to and operatively associated with a pump 150. The pump 150 is configured to provide convective flux to the system 100 and may flow electrolyte into the electrochemical cell via a cell inlet 152 and the electrolyte may flow out of the cell into the tank 140 via cell outlet 154. The inlets and/or outlets can be channels, conduits, and/or tubes, or any other suitable pathway to flow a fluid. In some embodiments, the inlets and outlet may be configured to reverse the flow of a fluid, such that an inlet may be configured into an outlet and an outlet may be configured into an inlet. And while the figure depicts an inlet and an outlet, it should be understood that the system and methods described herein may have any suitable number of inlets and/or outlets (e.g., 3 inlets and/or outlets, 4 inlets and/or outlets, 5 inlets and/or outlets, 6 inlets and/or outlets) as this disclosure is not so limited.

In some embodiments, the method may comprise circulating an electrolyte comprising an electroactive species in an electrochemical cell comprising a positive electrode, a separator, a negative electrode. For example, as shown in FIG. 1B, the pump 150 may be actuated to generate circulation within the system 100, illustrated schematically by flows 160. Once circulation of the electrolyte initiates, a convective flux 162 is created within the electrochemical cell, such that the electrolyte circulates within the electrochemical cell and can flow into and out of the cell via the cell inlet 152 and the cell outlet 154, respectively. In some embodiments, the electrolyte comprises an electroactive species (or a salt or counterion of an electroactive species), such that circulating the electrolyte (e.g., an electrolyte) comprises circulating an electroactive species in an electrochemical cell.

Various embodiments described herein use a pump in order to circulate the electrolyte. However, it should be understood that any suitable technique may be used to generate a convective flux. In some embodiments, a stir bar (e.g., a magnetic stir bar), a stir plate, a scintillator, a sonicator, vortex mixer, and/or a membrane (e.g., the deflection of a membrane), without limitation, may be used to provide flow or convection to the electrolyte. Other techniques to provide convection are possible as this disclosure is not so limited.

In some embodiments, the method comprises applying a voltage between the positive electrode and the negative electrode to generate an electromigrative flux of an electroactive species. That is, a voltage may be applied across the positive electrode and the negative electrode such that an electroactive species migrates to or from the electrodes to the electrolyte or from the electrolyte, depending on the polarity of the electrode. The electroactive species may be associated with or be an oxidation-reduction (redox) couple of another chemical species or a counterion of the electroactive species, and those skilled in the art in view of the present disclosure will understand that the electroactive species can be directly related to redox couple of the electroactive species and/or a counterion of the electroactive species. Thus, upon application of a voltage, an electromigrative flux of the electroactive species and/or a redox couple of the electroactive species and/or a counterion of the electroactive species may result. However, in some embodiments, the electromigrative flux may refer to just the electroactive species, such as lithium ions within the electrolyte, as a non-limiting example.

Various embodiments may also include components for monitoring and/or modulating heat with the system. For example, FIG. 1C shows that the system 100 may also include a thermal regulator 160 and a temperature sensor 162 for monitoring and/or modulating one or more thermal parameters of the system. The system may further comprise one or more additional thermal regulators and/or temperature systems. For example, as illustrated schematically in FIG. 1D, the system 100 comprises several temperature sensors 162 so that the temperature as different positions in the system can be taken and adjusted as desired. For many embodiments, the temperature sensors are in electrical communication with the thermal regulator, and hence the thermal regulator can receive temperature data from one or more thermal sensors in order to modulate a parameter of the system (e.g., increasing flow rate, heating the system, and/or cooling the system). Details regarding the thermal regulator and the temperature sensors is provided below.

The system and methods described herein may also describe a diffusive flux of an electroactive species, or some other species, within the electrolyte. The diffusive flux is directly related to the diffusion of a chemical species within the electrolyte (i.e., a solvent of the electrolyte). It has been recognized and appreciated within the context of the present disclosure that, in some embodiments, convection-enhanced systems (e.g., convection batteries) may have improved performance when the sum of the convective flux of an electroactive species and the diffusive flux of the electroactive species is greater than the electromigrative flux of the electroactive species (e.g., greater than one third the electromigrative flux) relative to an electrochemical cell without convection when all other relevant factors are essentially the same. In some embodiments, the sum of the convective flux and the diffusive flux is greater than the electromigrative flux relative to an electrochemical cell without convection with all other relevant factors are essentially the same. By way of illustration and not limitation, an electrochemical cell comprising a NMC positive electrode, a lithium metal negative electrode, and an electrolyte comprising LiPF₆, without convection, may perform better with convection when the added convective flux is greater than the sum of the diffusive flux and the electromigrative flux relative and using essentially the same NMC positive electrode, essentially the same lithium metal negative electrode, and essentially the same single electrolyte comprising LiPF₆. However, some other factors, which would be apparent to those of ordinary skill in the art, are not relevant to the outcome and can change.

In some embodiments, the electrolyte is flowed at a particular average velocity. For example, in some embodiments, circulating or flowing the electrolyte comprises flowing the electrolyte with an average velocity of greater than or equal to 0.001 μm/s and/or less than or equal to 10,000 μm/s. In some embodiments, circulating or flowing the electrolyte comprises flowing the electrolyte with an average velocity of greater than or equal to 0.0001 μm/s, greater than or equal to 0.001 μm/s, greater than or equal to 0.01 μm/s, greater than or equal to 0.1 μm/s, greater than or equal to 1 μm/s, greater than or equal to 2 μm/s, greater than or equal to 3 μm/s, greater than or equal to 4 μm/s, greater than or equal to 5 μm/s, greater than or equal to 10 μm/s, greater than or equal to 20 μm/s, greater than or equal to 50 μm/s, greater than or equal to 100 μm/s, greater than or equal to 500 μm/s, greater than or equal to 1,000 μm/s, greater than or equal to 2,500 μm/s, greater than or equal to 5,000 μm/s, or greater than or equal to 10,000 μm/s. In some embodiments, circulating comprise flowing the electrolyte with an average velocity of less than or equal to 10,000 μm/s, less than or equal to 5,000 μm/s, less than or equal 2,500 μm/s, less than or equal to 1,000 μm/s, less than or equal to 500 μm/s, less than or equal to 100 μm/s, less than or equal to 50 μm/s, less than or equal to 20 μm/s, less than or equal to 10 μm/s, less than or equal to 5 μm/s, less than or equal to 4 μm/s, less than or equal to 3 μm/s, less than or equal to 2 μm/s, less than or equal to 1 μm/s, less than or equal to 0.1 μm/s, less than or equal to 0.01 μm/s, less than or equal to 0.001 μm/s, or less than or equal to 0.0001 μm/s. Combinations of the above-referenced ranges are also possible (e.g., greater than or equal to 0.0001 μm/s and less than or equal to 10,000 μm/s). Other ranges are possible.

Various embodiments describe an electrochemical cell that has been enhanced with convection of the electrolyte. In some embodiments, the electrochemical cell comprises a positive electrode, a separator, and a negative electrode. The electrochemical cell (or a system comprising the electrochemical cell) may also comprise a tank holding an electrolyte, the electrolyte also further circulated through the electrochemical cell and a pump connected to the electrochemical cell and the tank to circulate the electrolyte. In some embodiments, the electrochemical cell may further comprise a current collector adjacent to the positive electrode and/or the negative electrode. Details regarding electrochemical cell components are provided below and elsewhere herein.

In some embodiments, the electrochemical system comprises a thermal regulator to cool and/or heat the system (e.g., an electrolyte or electrolyte solvent of the system). The thermal regulator may comprise one or more heating elements, chillers, coolers, and the like for modulating the temperature of the system (e.g., heating the system, cooling the system, maintaining the system at a set temperature). For example, in some embodiments, the thermal regulator comprises a heating element in fluidic contact with the electrolyte configured to heat the electrolyte. In some embodiments, the thermal regulator comprises a chiller or refrigeration unit (e.g., comprising a compressor) in fluidic contact with the electrolyte configured to cool the electrolyte. In some embodiments, the thermal regulator comprises a combination of one or more heating elements and/or refrigeration units. In some embodiments, one or more thermal regulators is disposed within the system (e.g., in an electrochemical cell, on an anode side of an electrochemical cell, in an electrolyte tank) in order to adjust the temperature in various positions within the system. Those skilled in the art in view of this disclosure will be capable of selecting appropriate cooling and/or heating elements for the thermal regulator for modulating the temperature of the system as desired.

In some embodiments, the thermal regulator is configured to heat the system (e.g., an electrolyte of the system). In some embodiments, the thermal regulator is configured to heat the electrolyte to a temperature of greater than or equal to 25° C., greater than or equal to 30° C., greater than or equal to 50° C., greater than or equal to 75° C., greater than or equal to 100° C., greater than or equal to 150° C., greater than or equal to 200° C., or greater than or equal to 250° C. In some embodiments, the thermal regulator is configured to heat the electrolyte to a temperature of less than or equal to 250° C., less than or equal to 200° C., less than or equal to 150° C., less than or equal to 100° C., less than or equal to 75° C., less than or equal to 50° C., less than or equal to 30° C., or less than or equal to 25° C. Combinations of the above-referenced ranges are also possible (e.g., greater than or equal to 30° C. and less than or equal to 250° C.). Other ranges are possible.

In some embodiments, the thermal regulator is configured to cool the system (e.g., an electrolyte of the system). In some embodiments, the thermal regulator is configured to cool the electrolyte to a temperature of less than or equal to 20° C., less than or equal to 15° C., less than or equal to 10° C., less than or equal to 5° C., less than or equal to 1° C., less than or equal to 0° C., less than or equal to −1° C., less than or equal to −5° C., or less than or equal to −10° C. In some embodiments, the thermal regulator is configured to cool the electrolyte to a temperature of greater than or equal to −10° C., greater than or equal to −5° C., greater than or equal to −1° C., greater than or equal to 0° C., greater than or equal to 1° C., greater than or equal to 5° C., greater than or equal to 10° C., greater than or equal to 15° C., or greater than or equal to 20° C. Combinations of the above-referenced ranges are also possible (e.g., greater than or equal to −10° C. and less than or equal to 20° C.). Other ranges are possible.

In some embodiments, the thermal regulator is configured to maintain the system (e.g., an electrolyte of the system) at a particular temperature. In some such embodiments, maintaining of the temperature comprises increasing the flowrate of the electrolyte, decreasing the flowrate of the electrolyte, heating the electrolyte, and/or cooling the electrolyte. In some such embodiments, the thermal regulator is configured to electrically communicate with one or more other portions of the system, such as a pump associated with the tank of the electrolyte, one or more temperature sensors of the system, and/or one or more cooling or heating elements. In some embodiments, the thermal regulator maintains a temperature of greater than or equal to −20° C., greater than or equal to −10° C., greater than or equal to −5° C., greater than or equal to −1° C., greater than or equal to 0° C., greater than or equal to 1° C., greater than or equal to 5° C., greater than or equal to, 10° C., greater than or equal to 15° C., greater than or equal to 20° C., greater than or equal to 25° C., greater than or equal to 30° C., greater than or equal to 50° C., greater than or equal to 75° C., greater than or equal to 100° C. greater than or equal to 150° C., greater than or equal to 200° C., or greater than or equal to 250° C. In some embodiments, the thermal regulator maintains a temperature of less than or equal to 250° C., less than or equal to 200° C., less than or equal to 150° C., less than or equal to 100° C., less than or equal to 75° C., less than or equal to 50° C., less than or equal to 30° C., less than or equal to 25° C., less than or equal to 20° C., less than or equal to 15° C., less than or equal to 10° C., less than or equal to 5° C., less than or equal to 1° C., less than or equal to 0° C., less than or equal to −1° C., less than or equal to −5° C., less than or equal to −10° C., or less than or equal to −20° C. Combinations of the above-referenced ranges are also possible (e.g., greater than or equal to −20° C. and less than or equal to 250° C.). Other ranges are possible.

For some embodiments, a temperature gradient between a first portion of the system (e.g., a cathode side of an electrochemical cell) and a second portion of the system (e.g., an anode side of an electrochemical cell) is maintained within a particular difference. In some embodiments, a temperature gradient between a first portion of the system and a second portion of the system is less than or equal to 20° C., less than or equal to 10° C., less than or equal to 5° C., less than or equal to 1° C., or less than or equal to 0.1° C. In some embodiments, a temperature gradient between a first portion of the system and a second portion of the system is greater than or equal to 0.1° C., greater than or equal to 1° C., greater than or equal to 5° C., greater than or equal to 10° C., greater than or equal to 20° C. Combinations of the above-referenced ranges are also possible (e.g., greater than or equal to 0.1° C. and less than or equal to 20° C.). Other ranges are possible.

Various embodiments include one or more temperature sensors within the system. In some such embodiments, the one or more temperature sensors is electrically coupled with the thermal regulator. In this manner, the temperature sensor(s) may provide data to the thermal regulator such that the thermal regulator may modulate (e.g., increase the temperature, decrease the temperature, maintain the temperature) of the system (e.g., an electrolyte within the system). Non-limiting examples of temperature sensors include negative temperature coefficient (NTC), thermistors, resistance-based temperature detectors (RTDs), thermocouples, and semiconductor-based sensors.

In some embodiments, the electrochemical cell comprises a positive electrode. In some embodiments, the positive electrode is a cathode. Many positive electrode materials or cathode materials are known in the art, and those skilled in the art in view of the present disclosure will be capable of selecting an appropriate positive electrode material or cathode material and also select the appropriate convection conditions to complement the positive electrode. In some embodiments, the positive electrode comprises a lithium intercalation compound, such as a nickel-manganese-cobalt (NMC) oxide compound or nickel cobalt aluminum (NCA) oxide that can reversibly intercalate and de-intercalate lithium ions. For example, the NMC compound may be a layered oxide, such as lithium nickel manganese cobalt oxide, LiNiₓMn_{y}Co₂O₂ or lithium nickel cobalt aluminum oxide, LiNiₓCo_{y}Al₂O₂ In some such embodiments, the sum of x, y, and z is 1. Other non-limiting examples of positive electrode materials include LiₓCoO₂ (e.g., Li_{1.1}CoO₂), LiₓNiO₂, LiₓMnO₂, LiₓMn₂O₄ (e.g., Li_{1.05}Mn₂O₄), LiₓCoPO₄, LiₓMnPO₄, and LiCoₓNi₍₁₋ₓ)O₂, where the value of x may be greater than or equal to 0 and less than or equal to 2 and the value of y may be greater than 0 and less than or equal to 2.

In some embodiments, the positive electrode material may be doped with one or more dopants to alter the electrical properties (e.g., electrical conductivity) of the cathode active material. Non-limiting examples of suitable dopants include aluminum, niobium, silver, and zirconium.

In some embodiments, the electrochemical cell comprises a negative electrode. In some embodiments, the negative electrode is an anode. Various negative electrode materials and anode active materials are known in the art, and those skilled in the art in view of the present disclosure will be capable of selecting an appropriate negative electrode material or anode active material and also select the appropriate convection conditions to complement the negative electrode. In some embodiments, the negative electrode comprises graphite or a graphitic material. For example, the negative electrode can comprise lithium-intercalated graphite. In some embodiments, the negative electrode comprises lithium metal. Other non-limiting examples of negative electrode materials include synthetic graphites, lithium titanate, silicon, and/or tin.

In some embodiments, the positive electrode and/or the negative electrode may independently have a current collector positioned adjacent to it. A variety of current collectors are known in the art. Suitable current collectors may include, for example, metals, metal foils (e.g., aluminum foil), polymer films, metallized polymer films (e.g., aluminized plastic films, such as aluminized polyester film), electrically conductive polymer films, polymer films having an electrically conductive coating, electrically conductive polymer films having an electrically conductive metal coating, and polymer films having conductive particles dispersed therein. In some embodiments, the current collector is or includes one or more conductive metals such as aluminum, copper, magnesium, chromium, stainless steel and/or nickel. Current collectors may include expanded metals, metal mesh, metal grids, expanded metal grids, metal wool, woven carbon fabric, woven carbon mesh, non-woven carbon mesh, and carbon felt, without limitation. Furthermore, a current collector may be electrochemically inactive. In other embodiments, however, a current collector may comprise an electroactive material or have an electrode active material deposited on a surface of the current collector.

In some embodiments, an electrode (e.g., a positive electrode, a negative electrode) may have a particular porosity. For example, in some embodiments, a porosity of the positive electrode and/or the negative electrode is greater than or equal to 20% and less than or equal to 70%. In some embodiments, the porosity of an electrode is greater than or equal to 20%, greater than or equal to 30%, greater than or equal 40%, greater than or equal to 50%, greater than or equal to 60%, or greater than or equal to 70%. In some embodiments, the porosity of an electrode is less than or equal to 70%, less than or equal to 60%, less than or equal to 50%, less than or equal to 40%, less than or equal to 30%, or less than or equal to 20%. Combinations of the above-referenced ranges are also possible (e.g., greater than or equal to 20% and less than or equal to 70%). Other ranges are possible.

An electrode (e.g., a positive electrode, a negative electrode) may have a particular thickness. For example, in some embodiments, a thickness of the positive electrode is greater than or equal to 5 μm and/or less than or equal to 5 cm. In some embodiments, a thickness of the negative electrode is less than or equal to 5 μm and/or less than or equal to 5 cm. In some embodiments, a thickness of an electrode is greater than or equal to 5 μm, greater than or equal to 10 μm, greater than or equal to 50 μm, greater than or equal to 100 μm, greater than or equal to 250 μm, greater than or equal to 500 μm, greater than or equal to 750 μm, or greater than or equal to 1000 μm. In some embodiments, a thickness of an electrode is less than or equal to 1000 μm, less than or equal to 750 μm, less than or equal to 500 μm, less than or equal to 250 μm, less than or equal to 100 μm, less than or equal to 50 μm, less than or equal to 10 μm, or less than or equal to 5 μm. In some embodiments, a thickness of an electrode is greater than or equal 0.1 cm, greater than or equal to 0.5 cm, greater than or equal to 1 cm, greater than or equal to 2 cm, greater than or equal to 3 cm, or greater than or equal to 5 cm. In some embodiments, a thickness of an electrode is less than or equal to 5 cm, less than or equal to 3 cm, less than or equal to 2 cm, less than or equal to 1 cm, or less than or equal to 0.5 cm, less than or equal to 0.1 cm. Combinations of the above referenced ranges are also possible (e.g., greater than or equal to 5 μm and less than or equal to 5 cm). Other ranges are possible as this disclosure is not so limited.

As mentioned above, the systems and methods described herein may include a separator between the positive electrode and the negative electrode. The separator may be made of any suitable material that provides conductivity to an electroactive species of the system (e.g., Li-ion conductivity) while acting as a barrier to the free flow of electrolyte (although, of course, some electrolyte may permeate the separator through the porosity of the separator).

A separator can be made of a variety of materials. For example, the separator may be or comprises a polymeric material in some instances, or be formed of an inorganic material (e.g., glass fiber filter papers) in other instances. Examples of suitable separator materials include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(e-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments still, the polymer may be selected from poly(n-pentene-2), polypropylene, polytetrafluoroethylene, polyamides (e.g., polyamide (Nylon), poly(e-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

As mentioned above and elsewhere herein, the systems and methods described include an electrolyte to circulate within an electrochemical cell. The electrolyte is a liquid that contains electroactive species (and counterions that may be associated with the electroactive species or a redox couple of the electroactive species). In many embodiments, the electrochemical cell contains one electrolyte containing one electroactive species. By contrast, as mentioned above, conventional flow cell batteries contain at least two electrolytes, a catholyte and an anolyte. However, many of the convection batteries or convection-enhanced systems described by the present disclosure contain just one electrolyte.

In some embodiments, an electrolyte (e.g., an electrolyte) has a particular diffusivity. For example, in some embodiments the single electrolyte has an effective diffusivity of greater than or equal to 1×10⁻¹⁰ cm²/s and/or less than or equal to 1×10⁻¹ cm²/s. In some embodiments, an electrolyte has a diffusivity of greater than or equal to 1×10⁻¹⁰ cm²/s. 1×10⁻⁹ cm²/s, 1×10⁻⁶ cm²/s, 1×10⁻⁵cm²/s. 10⁻³ cm²/s, 1×10⁻³ cm²/s, or 1×10⁻² cm²/s. In some embodiments, an electrolyte has a diffusivity of less than or equal to 1×10⁻² cm²/s. 1×10⁻³ cm²/s, 1×10⁻⁵cm²/s, 1×10⁻⁶ cm²/s, 1×10⁻⁹ cm²/s, or 1×10⁻¹⁰ cm²/s. Combinations of the foregoing are also contemplated (e.g., greater than or equal to 1×10⁻¹⁰ cm²/s and less than or equal to 1×10⁻² cm²/s). Of course, other ranges are possible as this disclosure not so limited.

In some embodiments, an electrode (e.g., a positive electrode, a negative electrode) may have a particular areal capacity, Q_{A}. For example, in some embodiments, areal capacity of the positive electrode and/or the negative electrode is greater than or equal to 0.01 mAh/cm² and less than or equal to 1 Ah/cm². In some embodiments, the areal capacity of an electrode is greater than or equal to 0.01 mAh/cm², greater than or equal to 0.05 mAh/cm², greater than or equal to 0.1 mAh/cm², greater than or equal to 0.2 mAh/cm², greater than or equal to 0.5 mAh/cm², greater than or equal to 0.7 mAh/cm², or greater than or equal to 1.0 mAh/cm². In some embodiments, the areal capacity of an electrode is less than or equal to 1.0 mAh/cm², less than or equal to 0.7 mAh/cm², less than or equal to 0.5 mAh/cm², less than or equal to 0.3 mAh/cm², less than or equal to 0.2 mAh/cm², less than or equal to 0.1 mAh/cm², less than or equal to 0.05 mAh/cm², or less than or equal to 0.01 mAh/cm². Combinations of the foregoing ranges are also contemplated (e.g., greater than or equal to 0.01 mAh/cm² and less than or equal to 1.0 mAh/cm²). Other ranges are possible.

The electrolyte may comprise a solvent (i.e., an electrolyte solvent) to dissolve one or more compounds, such as an electrolyte salt (e.g., an electroactive species and a counterion of the electroactive species). Many electrolyte solvents are known in the art. The solvent may be an aqueous solvent or a non-aqueous solvent. Examples of useful non-aqueous solvents (i.e., non-aqueous liquid electrolyte solvents) include, but are not limited to, N-methyl acetamide, acetonitrile, acetals, ketals, esters (e.g., esters of carbonic acid, sulfonic acid, an/or phosphoric acid), carbonates (e.g., dimethyl carbonate, diethyl carbonate, ethyl methyl carbonate, propylene carbonate, ethylene carbonate, fluoroethylene carbonate, difluoroethylene carbonate), vinylene carbonate, sulfones, sulfites, sulfolanes, sulfonamides (e.g., bis(trifluoromethane)sulfonimide lithium salt), ethers (e.g., aliphatic ethers, acyclic ethers, cyclic ethers), glymes, polyethers, phosphate esters (e.g., hexafluorophosphate), siloxanes, dioxolanes, N-alkylpyrrolidones (e.g., N-methyl-2-pyrrolidone), nitrate containing compounds, substituted forms of the foregoing, and blends thereof. Examples of acyclic ethers that may be used include, but are not limited to, diethyl ether, dipropyl ether, dibutyl ether, dimethoxymethane, trimethoxymethane, 1,2-dimethoxyethane, diethoxyethane, 1,2-dimethoxypropane, and 1.3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Other electrolyte solvents are possible as this disclosure is not so limited. In some embodiments, mixtures or combinations of the foregoing are possible. For example, in some embodiments, the single electrolyte comprises ethylene carbonate, ethyl methyl carbonate, and/or vinylene carbonate.

The electrolyte may comprise a compound or salt to provide ion conductivity to the electrochemical cell. In some embodiments, an electroactive species may be present within the electrolyte as an ionic electrolyte salt. Non-limiting examples of electrolyte salts for use in the electrolyte of the electrochemical cells described herein include, but are not limited to, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂, and lithium bis(fluorosulfonyl)imide (LiFSI). In some embodiments, the single electrolyte comprises lithium hexafluorophosphate.

The electrolyte may have a particular concentration (e.g., an initial concentration) of a compound or salt (e.g., an electrolyte salt). For example, in some embodiments, the electrolyte has an initial electrolyte concentration of greater than or equal to 10 mM and/or less than or equal to 5 M. In some embodiments, the concentration of the electrolyte is greater than or equal to 10 mM, greater than or equal to 25 mM, greater than or equal to 50 mM, greater than or equal to 100 mM, greater than or equal to 250 mM, greater than or equal to 500 mM, or greater than or equal to 750 mM. In some embodiments, the concentration of the electrolyte is less than or equal to 750 mM, less than or equal to 500 mM, less than or equal to 250 mM, less than or equal to 100 mM. less than or equal to 50 mM, less than or equal to 25 mM, or less than or equal to 10 mM. In some embodiments, the concentration of the electrolyte is greater or equal to 1 M, greater than or equal to 2 M, greater than or equal to 3 M, greater than or equal to 4 M, or greater than or equal to 5 M. In some embodiments, the concentration of the electrolyte is less than or equal to 5 M, less than or equal to 4 M, less than or equal to 3 M, less than or equal to 2 M, or less than or equal to 1 M. Combinations of the above-referenced ranges are also possible (e.g., greater than or equal to 10 mM and less than or equal to 5 M). Other ranges are possible.

The electrolyte may have a certain transference number. As understood by those skilled in the art, the portion of an applied current carried by an electroactive species (e.g., Li⁺, a counterion of the electroactive species). The transference number is customarily represented by the symbol t₊ or t₋, depending on the charge of the species and sum of the transference number is 1 for a particular electroactive species and its corresponding counterion. In some embodiments, the transference number of the electroactive species (e.g., a positively charged electroactive species, such as Li⁺) is greater than or equal to 0.1. 0.2. 0.3, 0.4, or 0.5. In some embodiments, the transference number of the electroactive species is less than or equal to 0.5, 0.4, 0.2, 0.3, 0.2, or 0.1. Combinations of the foregoing ranges are also contemplated (e.g., greater than 0.1 and less than 0.5). Of course, other ranges are possible as this disclosure is not so limited.

In some embodiments, the systems and methods comprise a tank. The tank may be adapted and arranged to contain the liquid electrolyte and to allow for convection of the liquid electrolyte. Many suitable containers exist, and can be a tank, a vessel, a reservoir, or the like. In some embodiments, the tank holds an electrolyte. The tank may be connected to other portions of the system (e.g., the electrochemical cell, the pump, an electrode) via one or more conduits, channels, or tubing.

As mentioned above, a pump may be used to flow or otherwise provide convection to an electrolyte within an electrochemical cell. However, it should also be understood that convection may be provided without a pump, or in combination with the pump, using other techniques, such as a stir bar, stir plate, a scintillator, a sonicator, vortex mixer, and/or a membrane (e.g., the deflection of a membrane), without limitation.

The pump may be configured to provide a particular flow rate. In some such embodiments, the pump comprises or is associated with a flow controller for adjusting and/or maintaining a flow rate. For example, in some embodiments, the pump is configured to provide an average flow rate to the electrolyte of greater than or equal to 0.5 μm/s or greater than or equal to 2.1 μm/s. In some embodiments, the pump is configured to provide an average flow to the electrolyte of greater than or equal to 0.001 μm/s, 0.01 μm/s, 0.1 μm/s, 0.5 μm/s, greater than or equal to 1 μm/s, greater than or equal to 10 μm/s, greater than or equal to 25 μm/s, greater than or equal to 50 μm/s, greater than or equal to 100 μm/s, greater than or equal to 500 μm/s, greater than or equal to 1,000 μm/s, greater than or equal to 2,500 μm/s, greater than or equal to 5,000 μm/s, or greater than or equal to 10,000 μm/s. In some embodiments, the pump is configured to provide an average flow rate to the electrolyte of less than or equal to 10,000 μm/s, less than or equal to 5,000 μm/s, less than or equal to 2,500 μm/s, less than or equal to 1,000 μm/s, less than or equal to 500 μm/s, less than or equal to 100 μm/s, less than or equal to 50 μm/s, less than or equal to 25 μm/s, less than or equal to 10 μm/s, less than or equal to 1 μm/s, less than or equal to 0.5 μm/s, less than or equal to 0.1 μm/s, less than or equal to 0.01 μm/s, or less than or equal to 0.001 μm/s. Combinations of the above-referenced ranges are also possible (e.g., greater than or equal to 0.001 μm/s and less than or equal to 10,000 μm/s). The electrolyte may also have an average velocity of or within any of the above-referenced ranges.

The convection-enhanced systems and methods described herein may be used in a variety of applications. In some cases, the systems and methods may be used to provide heat and/or thermal management to a battery or system of batteries. In some cases, the convection-enhanced systems and methods may be particularly suitable in scenarios where a high rate or fast discharge/charge are desired over a substantial portion of use.

For example, advantageous uses can be vehicles (both manned and unmanned), such as, hybrid and electric automobiles (including cars, trucks, buses, scooters, motorcycles), aircraft, aquatic vessels (including ships, boats, and jet skis), bicycles; storage and load leveling systems in combination with variable renewable energy technologies, such as, photovoltaic cells; wind turbines, and wave and tidal energy capture devices; storage and load leveling of grid electricity; power tools and outdoor equipment, such as lawnmowers; remote field energy storage and use (e.g. power packs for military, outdoor recreational purposes); industrial or municipal uses, such as, forklifts; construction equipment, such as heavy earth-moving machinery; personal mobility devices, such as, wheelchairs, golf carts, and go-karts; and indoor appliances, such as, vacuum cleaners, without limitation. Of course, many other applications are possible in scenarios that require electrical power on demand.

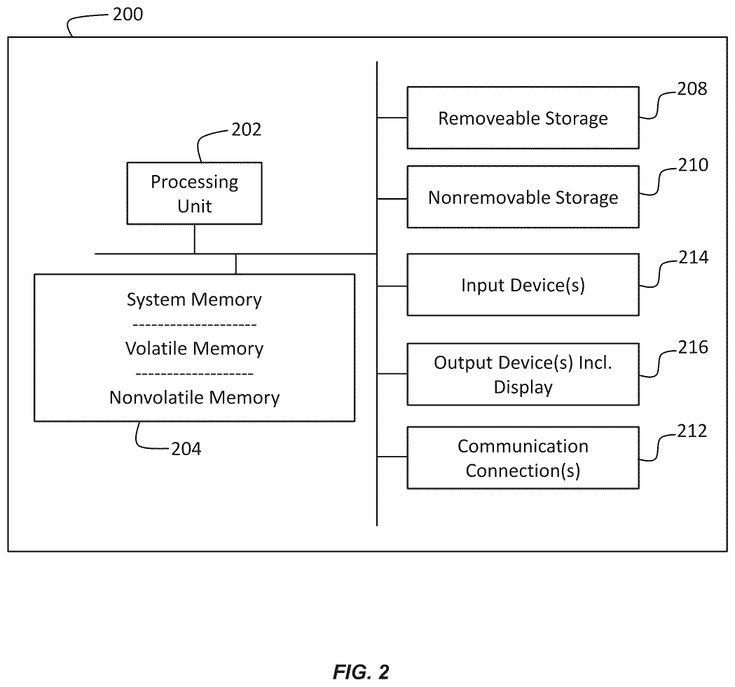

A computer system can implement a model of a convection-enhanced energy storage system with thermal regulation, for example for simulation to select parameters for such an energy storage system. Such a simulation can be implemented on a general purpose computer as described in connection with FIG. 2 below, according to the example implementation described in Examples 1 and 2. The model includes one or more of the following: a convection term in a Nernst-Planck equation representing the convection enhanced energy storage system; boundary conditions of a cell of the convection enhanced energy storage system to account for forced convection at boundaries; gauging conservation of anions within an external tank; and calculating electrode active area as a function of porosity.

An example implementation is described in the below Example, which is hereby incorporated by reference.

Having now described an example implementation, FIG. 2 illustrates an example of a general-purpose computing device with which can be used to implement the modeling as described herein. This is only one example of a computing device and is not intended to suggest any limitation as to the scope of use or functionality of such a computing device. The computer system described above can be implemented in one or more computer programs executed on one or more such computing device, such as a general-purpose computer as shown in FIG. 2.

FIG. 2 is a block diagram of a general-purpose computer which processes computer program code using a processing system. Computer programs on a general-purpose computer typically include an operating system and applications. The operating system is a computer program running on the computer that manages and controls access to various resources of the computer by the applications and by the operating system, including controlling execution and scheduling of computer programs. The various resources typically include memory, storage, communication interfaces, input devices, and output devices. Management of such resources by the operating system typically includes processing inputs from those resources, scheduling use of those resources, and providing outputs from those resources.

Examples of such general-purpose computers include, but are not limited to, larger computer systems such as server computers, database computers, desktop computers, laptop and notebook computers, as well as mobile or handheld computing devices, such as a tablet computer, handheld computer, smart phone, media player, personal data assistant, audio or video recorder, or wearable computing device.

With reference to FIG. 2, an example computer 200 comprises a processing system including at least one processing unit 202, also called a processing device, and a memory 204. The computer can have multiple processing units 202 and multiple devices implementing the memory 204. A processing unit 202 may comprise at least one hardware processor, and can include one or more processing cores (not shown) that operate independently of each other. Additional co-processing units, such as graphics processing unit 220, also can be present in the computer. The memory 204 may include volatile devices (such as dynamic random access memory (DRAM) or other random access memory device), and non-volatile devices (such as a read-only memory, flash memory, and the like) or some combination of the two, and optionally including any memory available in a processing unit. Other memory such as dedicated memory or registers also can reside in a processing unit. This configuration of memory is illustrated in FIG. 2 by line 204. The computer 200 may include additional computer storage (removable or non-removable) including, but not limited to, magnetically recorded or optically recorded disks or tape. Such additional computer storage is illustrated in FIG. 2 by removable storage 208 and non-removable storage 210. The various components in FIG. 2 typically are interconnected by an interconnection mechanism, such as one or more buses 230.

A computer storage medium is any medium in which data can be stored in and retrieved from addressable physical storage locations by the computer. Computer storage media includes volatile and nonvolatile memory devices, and removable and non-removable storage devices. Memory 204, removable storage 208 and non-removable storage 210 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 200 may also include communications connection(s) 212 that allow the computer to communicate with other devices over a communication medium. Communication media typically transmit computer program code, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal. thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 212 are devices, such as a network interface or radio transmitter, that interface with the communication media to transmit data over and receive data from signals propagated through communication media.

The communications connections can include one or more radio transmitters for telephonic communications over cellular telephone networks, or a wireless communication interface for wireless connection to a computer network. For example, a cellular connection, a Wi-Fi connection, a Bluetooth connection, and other connections may be present in the computer. Such connections support communication with other devices, such as to support voice or data communications.

The computer 200 may have various input device(s) 214 such as various pointer (whether single pointer or multi-pointer) devices, such as a mouse, tablet and pen, touchpad and other touch-based input devices, stylus, image input devices, such as still and motion cameras, audio input devices, such as a microphone. The computer may have various output device(s) 216 such as a display, speakers, printers, and so on, also may be included. These devices are well known in the art and need not be discussed at length here.

The various storage 210, communication connections 212, output devices 216 and input devices 214 can be integrated within a housing of the computer or can be connected through various input/output interface devices on the computer, in which case the reference numbers 210, 212, 214 and 216 can indicate either the interface for connection to a device or the device itself as the case may be.

An operating system of the computer typically includes computer programs, commonly called drivers, which manage access to the various storage 210, communication connections 212, output devices 216 and input devices 214. Such access can include managing inputs from and outputs to these devices. In the case of communication connections, the operating system also may include one or more computer programs for implementing communication protocols used to communicate information between computers and devices through the communication connections 212.

Each component (which also may be called a “module” or “engine” or the like), of a computer system and which operates on one or more computers, can be implemented as computer program code processed by the processing system(s) of one or more computers. Computer program code includes computer-executable instructions or computer-interpreted instructions, such as program modules, which instructions are processed by a processing system of a computer. Such instructions define routines, programs, objects, components, data structures, and so on, that, when processed by a processing system, instruct the processing system to perform operations on data or configure the processor or computer to implement various components or data structures in computer storage. A data structure is defined in a computer program and specifies how data is organized in computer storage, such as in a memory device or a storage device, so that the data can accessed, manipulated, and stored by a processing system of a computer.

In some embodiments, a convection enhanced energy storage system is described, the system comprising an electrochemical cell comprising a positive electrode, a separator, and a negative electrode; a tank holding an electrolyte, the electrolyte also further circulated through the electrochemical cell; and a pump connected to the electrochemical cell and the tank to circulate the electrolyte. In some embodiments, the convection enhanced energy storage system has parameters determined using a computer system as described above. In some embodiments, the convection enhanced energy storage system has large γ and β values, which has high transport resistance from diffusion and there is limited salt in the electrolyte solution to compensate. In some embodiments, the convention enhanced energy storage system has high applied current density, low electrode porosity, low Li+ transference number, and active materials with high specific capacity.

In some embodiments, a computer system comprising a processing system is described including a processing unit and computer storage, the processing system processing computer program instructions to implement a model of a convection enhanced energy storage system. In some embodiments, the computer system has a model that includes one or more thermal parameters, as described above and elsewhere herein.

In various embodiments, a computer such as computer 200, or a processor such as processing unit 202, or other control circuitry may comprise a controller configured to carry out control of a battery or a battery system including a battery. For example, the controller may control temperature of a battery (e.g., as a thermal regulator of the battery), may control circulation within a battery (e.g., circulation of an electrolyte of the battery, a pump of the system), or may control other aspects of the battery described herein.

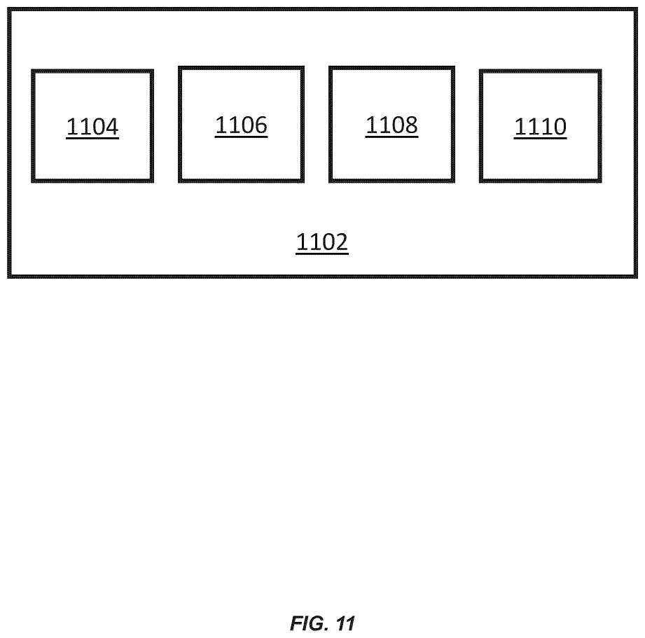

FIG. 11 shows an exemplary battery system configured to control circulation of an electrolyte of a battery, according to some embodiments. As illustrated in FIG. 11, there may be a battery system 1102 comprising an electrolyte 1104, a sensor 1106 (e.g., a temperature sensor), a controller 1108, and a circulator 1110. According to aspects of the disclosure, the battery system may comprise one of the various battery systems described herein, such a battery of system 100, described with respect to FIGS. 1A-1D. Further, electrolyte 1104 may include one of the electrolytes described herein, such as those contained in a battery cell having a positive electrode side 112 and a negative electrode side 122, where the electrolyte may further be flowed in flow channels such as cell inlet 152, cell outlet 154, and tank 140. In various embodiments, sensor 1106 may comprise a temperature sensor such as temperature sensor 162, or other sensor described herein. Further, the circulator 1110 may comprise a pump, such as pump 150 described above, or another device configured to circulate the electrolyte 1104 of the battery system 1102, as described herein.

According to aspects of the disclosure, the controller 1108 may be configured to control the circulation of electrolyte 1104 using the circulator 1110. In some embodiments, the controller may be configured to control the circulator 1110 using the sensor. In various embodiments, the controller 1108 may comprise a computer such as computer 200, or a processor such as processing unit 202, or another control circuit. For example, the controller 1108 may be configured to control the circulator 1110 to control circulation of the electrolyte 1104 in response to sensor data obtained by the controller 1108 from the sensor 1106. For example, in some embodiments, the controller 1108 may use the circulator 1110 to adjust a flow rate of the electrolyte 1104 by setting the circulator 1110 to have a particular pump rate, based on one of the equations provided herein and data obtained from the sensor 1106. In other embodiments, the controller 1108 may use the circulator 1110 to adjust a flow rate of the electrolyte 1104 by setting the circulator 1110 to have a particular pump rate, and further by setting a thermal regulator that comprises a heating element (not pictured in FIG. 11 but described elsewhere in the disclosure, e.g. thermal regulator 160), based on one of the equations provided herein and data obtained from the sensor 1106, as temperature of the electrolyte 1104 may be affected or controlled based on both flow rate and a thermal regulator.

In various embodiments, the controller 1108 may control the circulation in order to affect one or more factor of the battery system 1102, which may be an operating factor of the battery system. In some embodiments, the one or more factor affected by the controller may include cell discharge capacity of the battery system 1102, concentration profile of at least one electrolyte species of the battery system 1102, or heat generated by the cell of the battery system 1102, among other factors of the battery system 1102.

In certain embodiments, the controller 1108 may provide battery system 1102 with improved performance over conventional battery systems not having such a controller. For example, the controller 1108 may provide battery system 1102, when compared with a conventional battery system including an essentially identical cell as battery system 1102 but absent the controller 1108 (and in some embodiments, further absent the sensor 1106 and the circulator 1110), at least one of the parameters described above (such as (cell discharge capacity, concentration profile of at least one electrolyte species, or heat generated, among other factors of the battery system 1102) can differs by at least 1% (e.g., differs by greater than or equal to 1%, greater than or equal to 2%, greater than or equal to 3%, greater than or equal to 5%, greater than or equal to 10%; differs by less than or equal to 10%, less than or equal to 5%, less than or equal to 3%. less than or equal to 2%, less than or equal to 1%). As one example of cell (e.g., an electrochemical cell) that essentially identical, such a cell would include a first electrode, a second electrode, an electrode, and pump, fan, or the like to circulate the electrode between the first electrode and the second electrode. Comparing such a cell to an inventive system as described herein, the controller would provide improved electrochemical cell and/or battery management relative to the comparative cell that does not include a controller as described herein.

The following example is intended to illustrate certain embodiments of the present invention but does not exemplify the full scope of the invention.

### EXAMPLE

The example below physical describes an electrochemical system in which heat has been considered along with convective flux of the system.

A convection battery model was developed, using LIONSIMBA+c, by extending the Li-ION SIMulation BAttery Toolbox (LIONSIMBA), a pseudo two-dimensional (P2D)-based model that has been validated against COMSOL MultiPhysics commercial software and Newman's Fortran DUALFOIL. By introducing a convection term to the governing electrolyte mass transport equation and including a continuity equation to describe the electrolyte tank, the impact of bulk convection on cell performance was investigated as a function of component geometries, electrolyte properties, and cell operating conditions. The capabilities of LIONSIMBA+c were expended to include the study of heat transfer within a convection battery. Specifically, the following steps were taken: (1) incorporated a convection term into the governing heat transport equations for the electrodes and separator, (2) amended the boundary conditions to account for the flowing electrolyte at the inlet and outlet of the cell, (3) adjusted the heat transport equation at the both current collectors to account for the cell design change due to the addition of electrolyte tubing, (4) incorporated energy conservation equations to track the electrolyte temperature within the external tank under a range of assumptions about its heat exchange mode with the surrounding environment including isothermal, adiabatic, ambient cooling, and constant heat flux input/output.

The original LIONSIMBA software package considers both isothermal and non-isothermal cell operation. For non-isothermal operation, the model adopts a general thermal treatment to simulate the temperature change within a Li-ion battery cell. Similar to the description of electrolyte mass transport, the thermal model assumes that the cell temperature is radially uniform but that spatial temperature gradients can exist in the axial direction. An assumption underlying this approach is that the lateral walls of the cell are well-insulated, and heat exchange with the environment only occurs at the current collectors at either end of the cell (axial). It is also assumed that the different phases within the cell are in local thermal equilibrium, i.e. T_{liquid}(x,t)=T_{solid}(x,t)=T(x,t). In LIONSIMBA+c, a convective heat transfer term is added into the transport equation for the electrodes and separator, as shown in Equation 1.

$${ρ}_{i} {C}_{p , i} \frac{\partial T ( x , t )}{\partial t} = \frac{\partial }{\partial x} [ {λ}_{i} \frac{\partial T ( x , t )}{\partial x} ] - {ρ}_{e} {C}_{p , e} v \frac{\partial T ( x , t )}{\partial x} + \{ \begin{matrix}{Q}_{ohm} + {Q}_{rxn} + {Q}_{rev} & if i ∈ \{ p , n \} \\ {Q}_{ohm} & if i ∈ \{ s \}\end{matrix} \qquad [ 1 ]$$

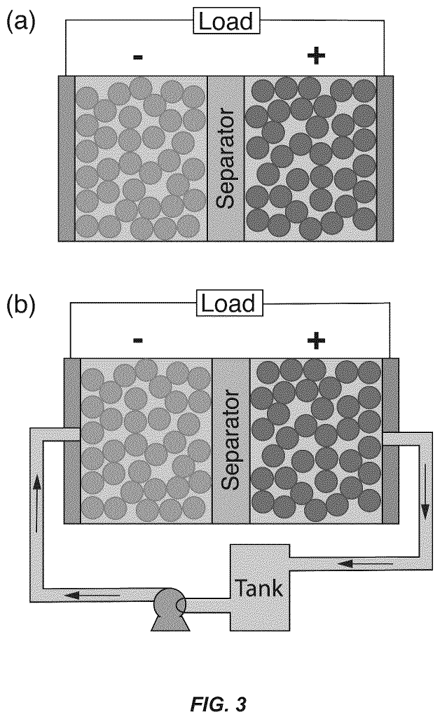

Here, ρᵢ, C_{p,i}, and λᵢ are the density, heat capacity, and thermal conductivity of domain i, where i∈{p, s, n} indicates the positive electrode (p), separator (s), or negative electrode (n), respectively, T(x,t) is the temperature at position x and time t, ρₑ is the electrolyte density, C_{p,e} is the electrolyte heat capacity, and v is the electrolyte superficial velocity, which is assumed to be constant throughout the cell. While there exist many possible sources of heat generation in a Li-ion battery cell,⁶ the model considers three major sources: (1) Qₒₕₘ, the heat generation from ohmic resistance (Joule heating); (2) Qᵣₓₙ, the irreversible reaction heat generation due to activation overpotential; (3) Qᵣₑᵥ, the reversible reaction heat generation due to entropy change. As shown in FIG. 3B, the convection cell configuration contemplated in this example assumes that the electrolyte flow enters and exits the electrochemical cell through tubes located at the center of the current collectors. It is assumed that the tubes are well-insulated and do not exchange heat with the surrounding environment or the current collectors. At the inlet and outlet, the Danckwerts boundary conditions shown in Equations 2 and 3 are implemented.

$$\begin{matrix}{{A}_{cell} {N}_{inlet} = [ - ( {A}_{cell} - {A}_{tube} ) {λ}_{i , {flow}^{i n}} \frac{\partial T ( x , t )}{\partial x} + {A}_{cell} {ρ}_{e} {C}_{p , e} vT ( x , t ) ] \vert}_{{flow}^{i n}} \\ {= [ - {A}_{cell} {λ}_{i , {flow}^{out}} \frac{\partial T ( x , t )}{\partial x} + {A}_{cell} {ρ}_{e} {C}_{p , e} vT ( x , t ) ] \vert}_{{flow}^{out}}\end{matrix} \qquad [ 2 ]$$

$$\begin{matrix}{{A}_{cell} {N}_{outlet} = [ - ( {A}_{cell} - {A}_{tube} ) {λ}_{i , {flow}^{out}} \frac{\partial T ( x , t )}{\partial x} + {A}_{cell} {ρ}_{e} {C}_{p , e} vT ( x , t ) ] \vert}_{{flow}^{out}} \\ {= [ - ( {A}_{cell} - {A}_{tube} ) {λ}_{i , {flow}^{i n}} \frac{\partial T ( x , t )}{\partial x} + {A}_{cell} {ρ}_{e} {C}_{p , e} vT ( x , t ) ] \vert}_{{flow}^{i n}}\end{matrix} \qquad [ 3 ]$$

In Equations 2 and 3, A_{cell} and A_{tube} are the cross-sectional areas of the cell and the tube, respectively. The addition of the inlet/outlet tubes at the center of the current collectors necessitates modification of the heat transfer equations to account for the continuity in the output current, which results in Equation 4.

$${ρ}_{i} {C}_{p , i} \frac{\partial T ( x , t )}{\partial t} = \frac{\partial }{\partial x} [ {λ}_{i} \frac{\partial T ( x , t )}{\partial x} ] + \frac{{( \frac{{A}_{cell}}{{A}_{c . c}} {I}_{app} ( t ) )}^{2}}{{σ}_{i}} i ∈ \{ al , cu \} \qquad [ 4 ]$$

Here, A_{c.c.} is the current collector cross-sectional area where A_{c.c.}+A_{tube}=A_{cell}, and σᵢ is the electrical conductivity of the positive aluminum (al) and negative copper (cu) current collectors. The temperature change inside the external electrolyte tank is described by Equation 5:

$${V}_{tank} {ρ}_{e} {C}_{p , e} \frac{{dT}_{tank} ( t )}{dt} = \{ \begin{matrix}0 \\ \begin{matrix}{A}_{cell} {ρ}_{e} {C}_{p , e} v [ {T}_{i n} ( t ) - {T}_{tank} ( t ) ] + \\ \{ \begin{matrix}\begin{matrix}0 \\ {A}_{tank} {h}_{tank} ( {T}_{ambient} - {T}_{tank} ( t ) )\end{matrix} \\ {A}_{tank} q\end{matrix}\end{matrix}\end{matrix} \begin{matrix}\begin{matrix}\begin{matrix}Isothermal \\ Adiabatic\end{matrix} \\ Ambient Cooling\end{matrix} \\ Constant Input\end{matrix} \qquad [ 5 ]$$

For the purposes of modeling, it was assumed that the tank is well-mixed with a volume Vₜₐₙₖ and total surface area Aₜₐₙₖ. Four different heat exchange conditions between the tank and the surrounding environment are considered in the model: (1) Isothermal, where the tank remains at its initial temperature at all times; (2) adiabatic, where the tank does not exchange heat with its surroundings, and the temperature change is only due to the electrolyte flowing into and out of the tank (3) ambient cooling, where the surface of the tank exchanges heat with the surroundings via convective cooling and hₜₐₙₖ is the convective heat transfer coefficient of the tank; and (4) constant input, where there is constant heat flux q into (q is positive) or out of (q is negative) the tank through its surface. The parameters used for the simulations performed in this example are shown below:

$${Q}_{o b m} = \{ \begin{matrix}\begin{matrix}{{σ}_{eff , i} ( \frac{\partial {Φ}_{s} ( x , t )}{\partial x} )}^{2} + {{κ}_{eff , i} ( \frac{\partial {Φ}_{e} ( x , t )}{\partial x} )}^{2} + \\ \frac{2 {κ}_{eff , i} R T ( x , t )}{F} ( 1 - {t}_{+} ) \frac{\partial ln {c}_{e} ( x , t )}{\partial x} \frac{\partial {Φ}_{e} ( x , t )}{\partial x}\end{matrix} & if i ∈ \{ p , n \} \\ \begin{matrix}{{κ}_{eff , i} ( \frac{\partial {Φ}_{e} ( x , t )}{\partial x} )}^{2} + \\ \frac{2 {κ}_{eff , i} R T ( x , t )}{F} ( 1 - {t}_{+} ) \frac{\partial ln {c}_{e} ( x , t )}{\partial x} \frac{\partial {Φ}_{e} ( x , t )}{\partial x}\end{matrix} & if i ∈ \{ s \}\end{matrix}$$

$${Q}_{rxn} = F {a}_{i} j ( x , t ) {η}_{i} ( x , t ) where {η}_{i} ( x , t ) = {Φ}_{s} ( x , t ) - {Φ}_{e} ( x , t ) - {U}_{i}$$

$${Q}_{rev} = F {a}_{i} j ( x , t ) {Π}_{i} ( x , t ) where {Π}_{j} ( x , t ) = \frac{T Δ {S}_{j}}{{n}_{j} F} = ( \frac{T}{{n}_{j} F} ) * ( {n}_{j} F \frac{\partial {U}_{j}}{\partial T} ) = T \frac{\partial {U}_{j}}{\partial T}$$

$${{Q}_{rev} = {Fa}_{i} j ( x , t ) T ( x , t ) \frac{\partial {U}_{i}}{\partial T} \vert}_{{T}_{ref}} .$$

While this modeling framework supports the investigation of a wide range of component parameters and operating conditions, for clarity and tractability, the cell behavior under the following conditions was selected for this example. For all cell components, the literature-reported experimental values of density (ρ), heat capacity (Cₚ), and thermal conductivity (λ) were used. Temperature-dependent physicochemical properties (e.g., electrolyte diffusion coefficient) are described using the relationships implemented in the original LIONSIMBA. All the simulations were performed under galvanostatic mode, with the state of charge (SoC) range of 85.51% to 0.9%, a lower voltage limit of 2.5 V, and an upper temperature limits of 52° C.(325 K) was chosen based on the typical operating conditions and safety cutoffs for Li-ion batteries. For the subsequent simulations, we used a cell cross-sectional area of 1 cm² and an adiabatic tank with a cross-sectional area of 50 mL. The electrolyte in the tank and the cell have the same initial concentration of 1 M and same initial temperature of 25° C.(298 K). The use of 1 cm² is convenient for normalization and does not reflect a limitation of the model treatment. The findings of the work here scale to cells of various areas subject to cross sectional uniformity.

### Model Analysis

### Base Case Study

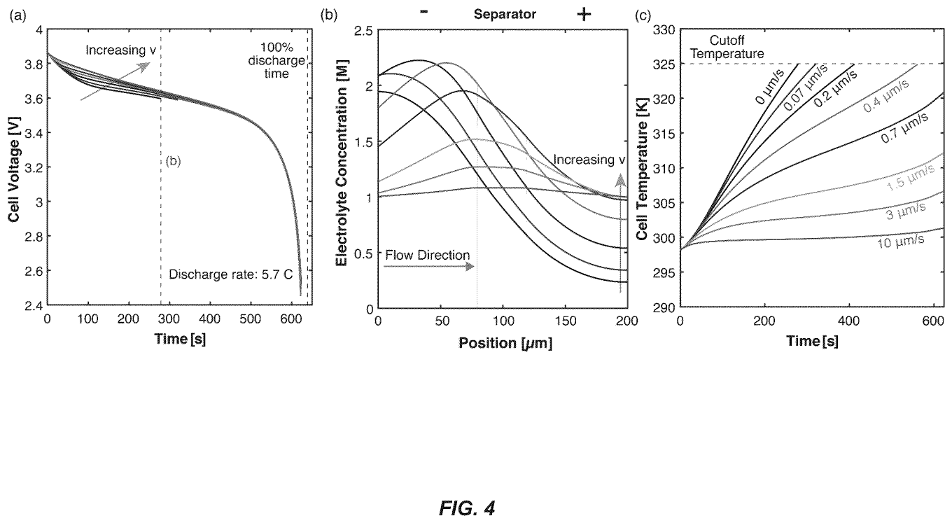

To illustrate how the consideration of the thermal effects impacts convection cell performance, a base case analysis described in prior work was repeated in which the galvanostatic discharge of a Li-ion battery cell with a stagnant electrolyte is simulated at 5.7 C under isothermal conditions. Under these conditions, the cell only accessed 60% of its theoretical capacity due to electrolyte salt depletion in the positive electrode; however, the introduction of convection lead to increased accessed capacity—98% at a superficial electrolyte velocity of 0.7 μm s⁻¹ or higher. As shown in FIG. 4A, the same simulation was performed, using the cell geometry, component properties, and operating conditions but isothermal assumption was relaxed and we allowed the cell temperature to vary freely. We found that the accessible capacity without flow is lower than in the isothermal case. As with the isothermal simulations, a large electrolyte concentration gradient developed across the cell during discharge, due to the competing effects of diffusion and electromigration. This gradient is gradually reduced by increasing electrolyte convection rates, as shown in FIG. 4B. However, unlike the isothermal simulations, complete electrolyte salt depletion in the positive electrode is not observed at the end of the discharge, indicating that electrolyte mass transport limitation is not the sole cause of the short runtime. Rather, in the absence of electrolyte flow, the cell temperature rises rapidly upon discharge and reaching the cutoff (e.g., safety cutoff) temperature prior to electrolyte depletion, as depicted in FIG. 4C. The rate of temperature rise can be slowed by convective flow, and a superficial electrolyte velocity of 0.7 μm s⁻¹ prevents the cell from reaching the cutoff temperature during the discharge period. Greater velocities further suppress cell temperature rise. Note that while the model simulates the cell temperature as a function of axial position, the temperature is uniform across the cell due to its thinness. Thus, the temperature shown in FIG. 4C represents both the average cell temperature and the temperature at all positions within the cell. FIG. 4 shows that the introduction of electrolyte flow simultaneously increased mass and thermal transport, both keeping the electrolyte concentration more uniform and mitigating cell temperature rise. Interestingly, the electrolyte superficial velocities provided to improve cell performance for both mass and thermal transport are similar, as a 10 μm s⁻¹ superficial velocity yields a near-uniform electrolyte concentration profile (FIG. 4B) and a temperature profile that remains close to the initial cell temperature (FIG. 4C). The corresponding pumping losses remained negligible compared to the energy gain on a per cell basis.

### Dimensionless Group Development

To enable compact analysis of the convection cell performance as a function of the individual cell properties and operating conditions, dimensionless groups that combine the large quantity of the physical parameters into a lower dimensional space were derived. For the single cell considered in this example, the temperature profile across the cell remained uniform, hence the focus was limited to dimensionless groups that describe the average cell temperature rise. The relevant quantities are (1) magnitude of ambient heat exchange rate of the cell, 2A_{c.c.}h_{cell} (Tₘₐₓ−T_{ambient})—in this case, the cell only exchanges heat with the surrounding environment through the current collectors at either end of the device; (2) magnitude of convective heat exchange rate with the tank, A_{cell}ρₑC_{p,e}v(Tₘₐₓ−T_{tank,init}); (3) average heat generation rate, Q̅ₜₒₜₐₗA_{cell}L_{cell}; and (4) Average heat storage rate,

$$\frac{\overline{ρ} {\overline{C}}_{p} {A}_{c e l l} {L}_{c e l l} ( {T}_{R} - {T}_{i n i t} )}{{t}_{dis}} .$$

The average volumetric heat generation rate, Q̅ₜₒₜₐₗ, can be estimated using the cell parameters and operating conditions. The multiplicative product of the average density, ρ̅, and the average heat capacity, C̅ₚ, can be calculated by averaging the ρCₚ products of each cell component weighted by their respective thicknesses. Comparing these quantities yields the list of dimensionless groups that can be used to evaluate the average cell temperature rise (shown in Table 1), which are subsequently denoted with the subscript H. To prevent any temperature rise, the heat removal rate from the cell must balance the heat generation rate within the cell. In the case of an enclosed system (e.g., a conventional Li-ion battery cell) where heat removal relies on ambient heat exchange, this ratio is captured by the dimensionless parameter γ_{H}. A large γ_{H} value indicates that the heat removal rate is insufficient, which, in turn, leads to temperature rise during charge/discharge operation. In the case of a convection battery, the electrolyte flow provides an additional mode of heat removal, and ξ_{H} compares the heat generation rate of the cell to the sum of heat removal rate through both ambient cooling and electrolyte convection. In the absence of convection, γ_{H}=ξ_{H}. Similar to γ_{H}, a large ξ_{H} value indicates insufficient combined heat removal as compared to heat generation. Finally, the inherent buffering ability of the cell against heat generation, as captured by β_{H}, must also be considered; where a large β_{H} value indicates the cell is more prone to temperature increase with the same amount of heat generation. The dimensionless groups for mass transport are also included in Table 1 for reference, and are subsequently denoted with the subscript M. These groups are analogous to those used to describe heat transport, where γ_{M} compares the electromigrative and diffusive fluxes, and a large value of γ_{M} indicates an increased likelihood for Li salt depletion in the positive electrode during discharge due to insufficient diffusive transport; ξ_{M} compares the electromigrative flux to the sum of diffusive and convective fluxes, and large values of ξ_{M} would indicate that the combined diffusive-convective fluxes are slower than the electromigrative flux removing ions from the cathode; β_{M} measures the buffering ability of the cell against electrolyte salt depletion, and a large β_{M} value indicates that the initial amount of salt in the electrolyte is insufficient compared to that can be depleted by the electromigration of ions.

TABLE 1
Select Parameters.

| Dimension- | | | |
|---|---|---|---|
| less group | Meaning | Mass Transport | Heat Transport |
| γ | Inherent transport ability | $\frac{{I}_{app} ( 1 - {t}_{+} ) L}{F {D}_{eff} {c}_{initial}}$ | $\frac{{\overline{Q}}_{t o t a l} {L}_{cell}}{2 \frac{{A}_{c . c .}}{{A}_{cell}} {h}_{cell} ( {T}_{max} - {T}_{a m b i e n t} )}$ |
| ξ | Transport ability with convection | $\frac{{I}_{app} ( 1 - {t}_{+} )}{\frac{F {D}_{eff} {c}_{initial}}{L} + F v {c}_{initial}}$ | $\frac{{\overline{Q}}_{total} {L}_{cell}}{\begin{matrix}2 \frac{{A}_{c . c .}}{{A}_{cell}} {h}_{cell} ( {T}_{max} - {T}_{ambient} ) + {ρ}_{e} {C}_{p , e} v ( {T}_{max} - {T}_{tank ,} \\ {ρ}_{e} {C}_{p , e} v ( {T}_{max} - {T}_{tank ,}\end{matrix}}$ |
| β | Buffering ability | $\frac{{I}_{a p p} {t}_{dis} ( 1 - {t}_{+} )}{F {c}_{initial} ε L}$ | $\frac{{\overline{Q}}_{t o t a l} {t}_{d i s}}{\overline{ρ} {\overline{C}}_{p} ( {T}_{max} - {T}_{i n i t} )}$ |

The corresponding dimensionless group values of the base case are shown in Table 2(a). The large γ and β values for both mass and heat transport indicate that without convection, the inherent mass and thermal transport properties of the cell are insufficient under the high discharge rate of 5.7 C, which explains the large electrolyte concentration gradient and rapid temperature increase shown in FIGS. 4B-4C, respectively.

TABLE 2
Dimensionless group values.

| | Base Case | Alternative Case I | Alternative Case II |
|---|---|---|---|
| γ_{M} | 2.0 | 2.0 | 2.0 × 10⁻⁵ |
| β_{M} | 16.2 | 16.2 | 16.2 |
| γ_{H} | 2.9 | 2.9 × 10⁻³ | 2.1 |

While the base case demonstrates that the introduction of electrolyte convection enables simultaneous enhancement on the mass and thermal transport, further investigation is needed to decouple the transport phenomena and elucidate the impact of convection on each. This can be achieved by two variations of the base case that only considers one of the transport limitations: (1) Alternative Case I, where without convection, the cell has good heat transfer capability but poor mass transport properties for the conditions used in the base case, (2) Alternative Case II, where the mass transport in the cell without convection is sufficiently facile, but the heat transfer capability is limited. The following sections discuss the findings from these two alternative cases.

### Alternative Case I Study

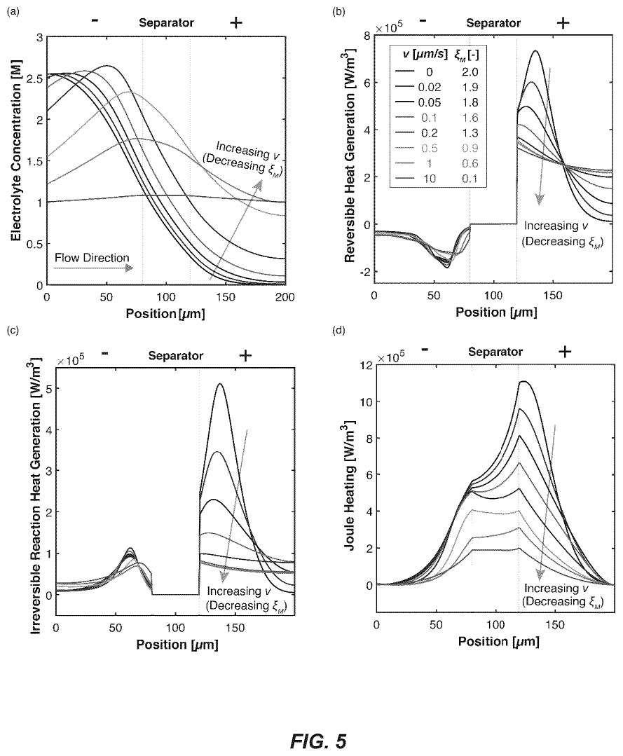

The first scenario we consider is a cell with a very large heat transfer coefficient (h_{cell}=500 W m⁻² K⁻¹) which eliminates temperature rise during the discharge period, while all the other conditions remain the same as the base case. The corresponding dimensionless group values are shown in Table 2(b). The heat transfer coefficient value chosen here is representative of a liquid cooling system, and this case corresponds to a cell with excellent heat removal capability (e.g., well-designed thermal regulation system) to maintain near-isothermal operating conditions, which approaches the isothermal base case. In the absence of an elevated average cell temperature, electrolyte mass transport presents significant limitations, which can be alleviated by increasing electrolyte convection (or decreasing ξ_{M} value) as shown in FIG. 5A. However, improved electrolyte mass transport rates also positively impact the thermal regulation of the cell. As shown in FIG. 5B, the more spatially uniform electrolyte concentration profile enables more even reversible heat generation within the cell, suggesting a more homogeneous reaction distribution, particularly within the Li-ion-consuming electrode (here, the positive electrode). Importantly, this observation implies that electrolyte convection can potentially help mitigate the critical issue of non-uniform reaction distribution that limits power output and capacity utilization for thick electrodes used in high energy-density cells. In addition, electrolyte convection can reduce irreversible reaction heat generation in the positive electrode and overall Joule heating as shown in FIG. 5C and FIG. 5D, respectively. As the convection enables a higher electrolyte concentration in the positive electrode, the activation overpotential required to sustain the desired current output is reduced due to a faster reaction rate, lowering irreversible reaction heat generation. Further, the more uniform electrolyte concentration allows the electrolyte conductivity to be near its maximum across the whole cell, resulting in decreased Joule heating. Collectively, these results demonstrate the electrolyte flow can reduce overall heat generation within a cell as well as enable greater spatially uniformity in heat generation. In this case, the average volumetric heat generation rate (Q̅ₜₒₜₐₗ) is halved. As previously mentioned, the temperature rise of a cell is determined by both the heat removal capability of the cell and its heat generation rate. The heat generation reduction effect observed here differentiates the convection battery from all other external and internal thermal regulation methods that focus on improving the heat removal capability, as the reduction in heat generation relaxes the requirement for heat removal capability in the first place.

### Alternative Case II Study

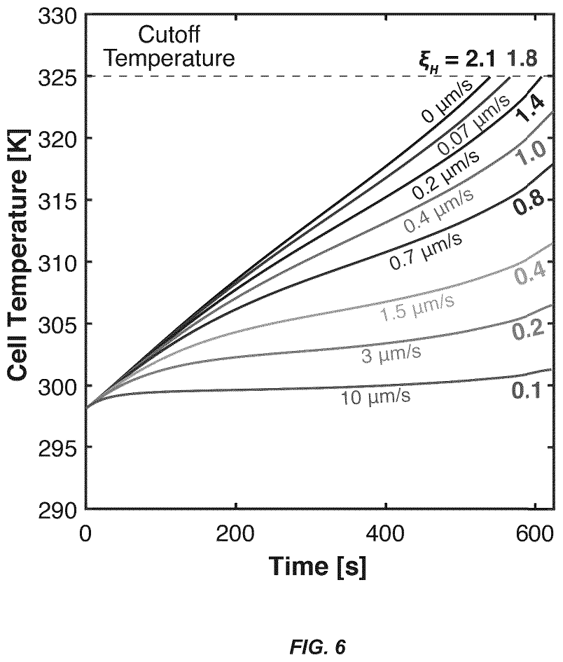

In the second scenario, we consider a cell with a very large electrolyte diffusivity (D=normal value×10⁵) to eliminate the electrolyte mass transfer limitation, while all the other conditions are kept the same as the base case described above. These diffusive rates are infeasible for practical electrolytes, the simulated conditions are instructive as they enable isolation of the effects of electrolyte convection on heat transfer. The corresponding dimensionless group values are shown in Table 2(c). The γ_{H} and β_{H} values are both lower than those of the base case, which is a result of the heat generation reduction via the elimination of mass transfer limitation as discussed in the previous case. This effect can also be observed in as shown in FIG. 6, where even without electrolyte flow, the cell can discharge for a longer time as compared to its counterpart in FIG. 4C. With the introduction of electrolyte flow, the temperature rise is further suppressed, and when ξ_{H}˜1, the cell can complete a full discharge without hitting the cutoff temperature. FIG. 6 demonstrates the second effect of electrolyte flow on thermal management, namely that bulk flow can remove heat from the cell to prevent temperature rise (i.e., increase heat removal capability of the cell). Additionally, the amount of flow provided to prevent the cell from hitting the cutoff temperature can be estimated from calculating the flowrate for ξ_{H}=1. Note that while convection can effectively prevent the cell temperature from rising, it might be beneficial for the cell to run at a slightly elevated temperature that leads to enhanced transport properties. This can be achieved by regulating the flowrate and/or introduce electrolyte of a different temperature, which can also be extended to other applications such as cold start.

### Comparison Between Internal and External Cooling

As previously discussed, the simultaneous mass and thermal transport enhancement by convection offers unique advantages for cell performance and temperature regulation compared to all the thermal management systems that regulate the cell temperature externally. This section demonstrates a direct comparison between the convection battery cooling method discussed in this study and the typical external thermal management systems. The two methods are referred to as “internal cooling” and “external cooling” respectively hereafter. We use the same cell as the base case that discharges at 5.7 C, which is essentially a coin cell. For external cooling, the cell exchanges heat with the surrounding environment through the two ends of the device (i.e. top and bottom cooled). For internal cooling, the cell is cooled by flowing electrolyte in the direction as shown in FIG. 3B. As previously mentioned, the temperature rise of the cell is determined by both heat generation and heat removal, and there is no temperature rise if the two balance each other. We first only consider heat removal capability of the two methods. For external cooling, the magnitude of heat exchange rate is 2A_{cell}h_{cell} (Tₘₐₓ−T_{ambient}). For internal cooling, the cell is cooled by max exchanging heat with the tank through the convecting electrolyte with a representative rate of A_{cell}ρₑC_{p,e}v(Tₘₐₓ−Tₜₐₙₖ). Assuming the tank remains at ambient temperature due to its large size compared to the cell, comparing these two quantities yields

$$\frac{External Cooling}{Internal Cooling} = 2 \frac{h}{{ρ}_{e} {C}_{p , e} v} .$$

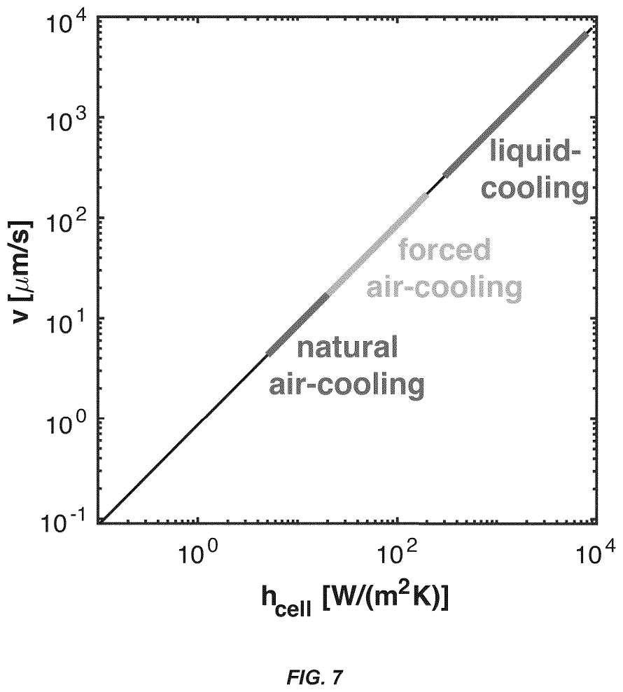

Note h/ρₑC_{p,e}v is also the expression for the Stanton number, but it is used differently in this context as it considers two different cooling fluids as opposed to a single fluid as defined for the Stanton number. The prefactor in the expression is determined by the cooling methods and the cell form factor, and it has a value of 2 in this case to account for the two cooling surfaces of the external cooling method. Equivalent heat removal capability should be expected for external and internal cooling methods when the expression has a value of 1. As ρₑ and C_{p,e} are known electrolyte properties, a relationship between v and h that would yield equivalent heat removal capability can be determined as shown in FIG. 7. When considering the interplay of mass transport, the corresponding v and h values in FIG. 7 do not have the same impact on cell temperature rise and performance.

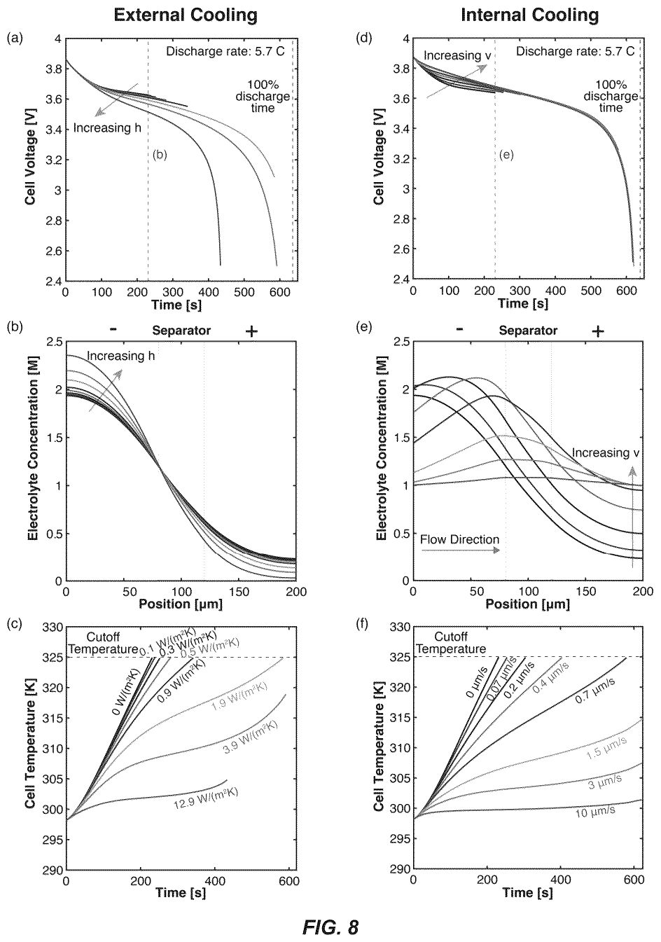

As demonstrated in FIG. 8, an “equivalent” set of v and h values that have the same heat removal capabilities based on FIG. 8 was selected. These show that an increasing h has opposite impact on the thermal and mass transport and can cause the cell to go from thermal transport limited to diffusion limited regions. This is in contrast with the internal cooling that enhances mass and thermal transport simultaneously. The coupled mass transport effect has more profound impact on the efficacy of internal and external thermal regulation. That is, internal cooling is more effective than the external cooling method with same heat removal capability. This is a result of the different heat generation due to their opposite impact on mass transport (internal cooling enhances mass transport whereas external cooling worsens it).

### Potential Use Case Demonstration Dynamic Flow Rate for Thermoregulation

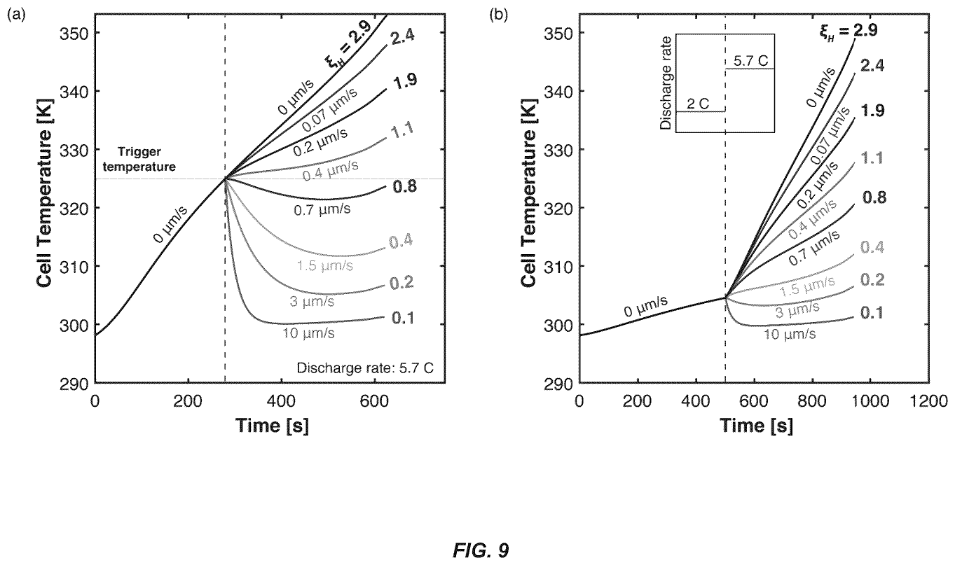

FIG. 9 demonstrates two potential use cases of thermal regulation by convection battery. In FIG. 9A, convection is introduced when the cell reaches a trigger temperature, and cell temperature rise is suppressed almost instantaneously. In FIG. 9B, convection is triggered by a change in C-rate, which serves as a preventative measure for thermal runaway. In both cases, the cell temperature stays below the cutoff temperature of 52° C. (325 K) when ξ_{H}˜<1.

### CONCLUSIONS

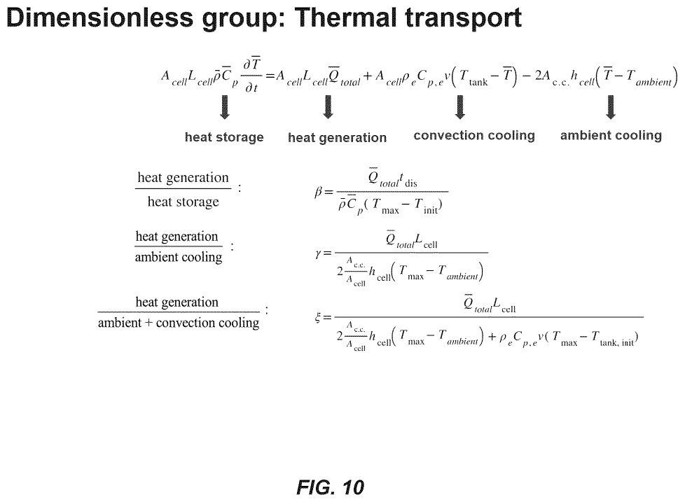

FIG. 10 describes some thermal parameters derived in the above example. (1) Convection can serve as an effective means of temperature control by carrying the generated heat out of the cell through the flowing medium; its efficacy is determined by numerous cell and operating parameters, and can be predicted using dimensional analysis. (2) The elimination of electrolyte concentration gradient by flow, and the resulting smaller ohmic resistance, concentration and activation overpotentials, also help prevent cell temperature rise through reduced heat generation rate. (3) While maintaining the cell at a lower temperature is desirable from a safety standpoint, a higher operating temperature could be beneficial to the cell performance, as kinetic and transport properties improve with increased temperature; the flowing electrolyte could offer a simple and effective way to regulate the cell temperature through controls of the electrolyte flowrate, temperature, etc.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B.” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of operating an electrochemical system with convection, the method comprising:
circulating an electrolyte comprising an electroactive species in an electrochemical cell comprising a positive electrode, a separator, a negative electrode;
applying a voltage between the positive electrode and the negative electrode; and
determining one or more thermal parameters of the electrochemical cell.

2. The method of claim 1, wherein the electrochemical system satisfies the condition
$$\frac{{\overline{Q}}_{total} L}{2 {h}_{cell} ( {T}_{max} - {T}_{ambient} ) + {ρ}_{e} {C}_{p . e} v ( {T}_{max} - {T}_{tank , init} )} < 3 ,$$
where Q̅ₜₒₜₐₗ is an average volumetric heat generation rate inside an electrochemical cell of the system, L is a characteristic length of internal flow, h_{cell} is the heat transfer coefficient of the cell, Tₘₐₓ is a threshold temperature of the cell, T_{ambient} is an ambient temperature, ρₑ is an electrolyte density, C_{p,e} is an electrolyte heat capacity, and v is an electrolyte superficial velocity, and T_{tank,init} is an initial temperature of the electrolyte inside an external storage tank.

3. A method of operating an electrochemical system with convection, the method comprising:
circulating an electrolyte comprising an electroactive species in an electrochemical cell comprising a positive electrode, a separator, a negative electrode;
applying a voltage between the positive electrode and the negative electrode,
wherein the electrochemical system satisfies the condition
$$\frac{{\overline{Q}}_{total} L}{2 {h}_{cell} ( {T}_{max} - {T}_{ambient} ) + {ρ}_{e} {C}_{p . e} v ( {T}_{max} - {T}_{tank , init} )} < 3 ,$$
where Q̅ₜₒₜₐₗ is an average volumetric heat generation rate inside an electrochemical cell of the system, L is a characteristic length of internal flow, h_{cell} is the heat transfer coefficient of the cell, Tₘₐₓ is a threshold temperature of the cell, T_{ambient} is an ambient temperature, ρₑ is an electrolyte density, C_{p,e} is an electrolyte heat capacity, and v is an electrolyte superficial velocity, and T_{tank,init} is an initial temperature of the electrolyte inside an external storage tank.

4. The method of claim 1, further comprising cooling the electrolyte to a temperature of less than or equal to −20° C.

5. The method of claim 1, further comprising heating the electrolyte to a temperature of greater than or equal to 250° C.

6. The method of claim 1, further comprising increasing a flow rate of the electrolyte to an average velocity of greater than or equal to 0.001 μm/s and/or less than or equal to 10,000 μm/s.

7. The method of claim 1, further comprising decreasing a flow rate of the electrolyte to an average velocity of greater than or equal to 0.001 μm/s and less than or equal to 10,000 μm/s.

8. The method of any one of claim 1, further comprising modulating a flow rate of the electrolyte such that a temperature gradient of the electrochemical system is less than or equal to 20° C.

9. The method of claim 1, wherein a thickness of the positive electrode is greater than or equal to 5 μm and less than or equal to 5 cm.

10. The method of any one of claim 1, wherein a thickness of the negative electrode is less than or equal to 5 μm and less than or equal to 5 cm.

11. The method of claim 1, wherein the electrolyte has an effective diffusivity of greater than or equal to 1×10⁻¹⁰ cm²/s and less than or equal to 1×10⁻¹ cm²/s.

12. The method of claim 1, wherein the electrolyte has an initial electrolyte concentration of greater than or equal to 10 mM and less than or equal to 5 M.

13. The method of claim 1, wherein a porosity of the positive electrode and/or the negative electrode is greater than or equal to 20% and less than or equal to 70%.

14. The method of claim 1, further comprising charging and discharging at a C-rate of greater than or equal to 0.001 h^{31 1} and less than or equal 1,000 h⁻¹.

15. The method of any one of claim 1, wherein a flow rate of the electrolyte is modulated after the electrolyte reaches a threshold temperature.

16. A convection-enhanced battery system, the system comprising:
a positive electrode comprising a lithium intercalation compound;
a separator adjacent to the positive electrode;
a negative electrode adjacent to the separator, the negative electrode comprising lithium-intercalated graphite or lithium metal;
a tank comprising an electrolyte;
a pump connected to the tank to circulate the electrolyte;
a thermal regulator, wherein the thermal regulator is configured to heat and cool the electrolyte.

17. The system of claim 16, wherein the thermal regulator is configured to heat the electrolyte to a temperature of greater than or equal to 200° C.

18. The system of claim 16, wherein the temperature controller is configured to cool the electrolyte to a temperature of less than or equal to −20° C.

19-24. (canceled)

25. The system of claim 16, further comprising a controller and at least one sensor, the controller configured to control circulation of the electrolyte responsive to at least one sensor, the pump, and/or the thermal regulator to affect at least one or more of the following parameters:
cell discharge capacity,
concentration profile of at least one electroactive species of the electrolyte, and/or
heat generated by the cell,
wherein, in an essentially identical cell but absent the controller, at least one of the factors differs by at least 1%.
